(19) United States
(12) Patent Application Publication
(10) Pub. No.: US 2025/0047975 A1
(43) Pub. Date: Feb. 6, 2025

(54) TRANSMISSION DEVICE

(71) Applicants: ASTRODESIGN, Inc., Tokyo (JP); TOKYO BROADCASTING SYSTEM TELEVISION, Inc., Tokyo (JP)

(72) Inventors: Yoshihito Manabe, Tokyo (JP); Koji Ono, Tokyo (JP); Hideto Nakamichi, Tokyo (JP); Naoyuki Sagara, Tokyo (JP); Shohei Suzuki, Tokyo (JP)

(73) Assignees: ASTRODESIGN, Inc., Tokyo (JP); TOKYO BROADCASTING SYSTEM TELEVISION, Inc., Tokyo (JP)

(21) Appl. No.: 18/793,072

(22) Filed: Aug. 2, 2024

(30) Foreign Application Priority Data
Aug. 4, 2023 (JP) 2023-127710

(51) Int. Cl. H04N 23/661; H04N 23/51

(52) U.S. Cl. CPC H04N 23/661; H04N 23/51

(57) ABSTRACT

A transmission device is configured to receive a video signal from an external camera in a form of a baseband signal and convert the video signal into an IP signal to transmit a video. The transmission device includes: a transmission unit configured to transmit, to a predetermined external device, a camera video that is being captured and is received from the camera; and a display provided in a housing of the transmission device.

### CROSS-REFERENCE TO RELATED APPLICATION

The present application claims priority from Japanese Application JP2023-127710, the content of which is hereby incorporated by reference into this application.

### BACKGROUND OF THE INVENTION

### 1. Field of the Invention

The present disclosure relates to a transmission device.

### 2. Description of the Related Art

A transmission device connectable to an external camera is known. For example, the transmission device is connected to a television camera and transmits, to a camera control unit in a control room, a video that is being captured and is input from the television camera. A known television camera receives a return video showing a video that is on air from the camera control unit and displays the return video on a display. See, for example, JP 2005-57499 A and JP 2015-133681 A. Functions such as transmission and reception of an intercom signal and reception and display of a tally display command are implemented in this transmission device, allowing signals necessary for camera operation to be exchanged by this single transmission device.

### SUMMARY OF THE INVENTION

Although the transmission device typically converts electricity into light and transmits the light, facilities such as studios have recently become IP-based, there are no devices that can comprehensively exchange signals of information necessary for camera operation between a studio sub-room or a production truck constructed with IP signals and a camera operated by a cameraman, and IP-enabled video transmission devices, IP-enabled intercom devices, and IP-enabled tally signal reception devices need to be individually prepared. This increases the time required for connection confirmation, connection adjustment, equipment preparation, and the like, causing an increase in program production costs.

An object of an aspect of the present disclosure is to provide a transmission device that can comprehensively handle information necessary for a cameraman to operate a camera in an environment in which a studio sub-room or a production truck constructed with IP signals is connected to the camera.

An aspect of the present disclosure is a transmission device configured to receive a video signal from an external camera in a form of a baseband signal and convert the video signal into an IP signal to transmit a video. The transmission device includes: a transmission unit configured to transmit, to a predetermined external device, a camera video that is being captured and is received from the camera; and a display provided in a housing of the transmission device.

### BRIEF DESCRIPTION OF THE DRAWINGS

FIG. 1 is a schematic diagram of a transmission system.

FIG. 2A is a front view of the transmission device.

FIG. 2B is a rear view of the transmission device.

FIG. 3 is a block diagram illustrating an electrical configuration of the transmission device.

FIG. 4A is an example of a screen displayed on a transmission device according to the first embodiment.

FIG. 4B is another screen example displayed on the transmission device according to the first embodiment.

FIG. 4C is another screen example displayed on the transmission device according to the first embodiment.

FIG. 5A is a first example of a screen displayed on a transmission device according to a second embodiment.

FIG. 5B is a second example of a screen displayed on the transmission device according to the second embodiment.

FIG. 5C is a third example of a screen displayed on the transmission device according to the second embodiment.

FIG. 6 is an example of a screen displayed on a transmission device according to a third embodiment.

### DETAILED DESCRIPTION OF THE INVENTION

Hereinafter, an embodiment of the present disclosure will be described with reference to the drawings. In the drawings, the same or equivalent elements are given the same reference numeral, and redundant descriptions will be omitted.

### First Embodiment

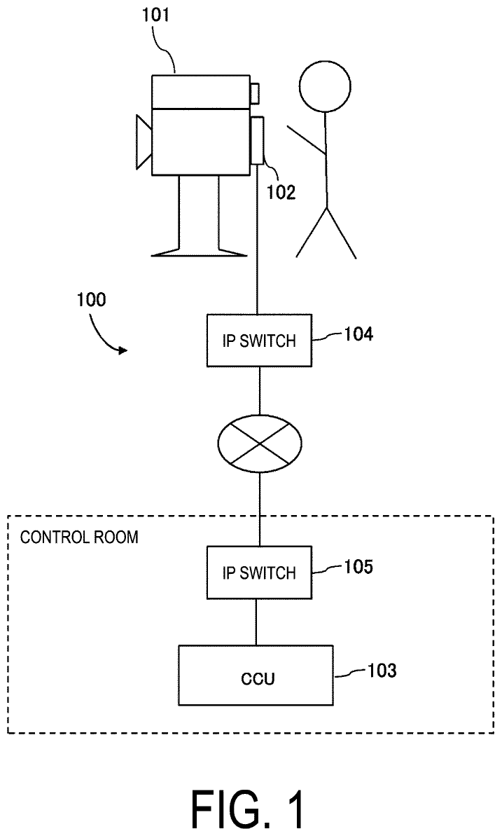

A first embodiment of the present disclosure will be described. FIG. 1 is a schematic diagram of a transmission system 100. As illustrated in FIG. 1, the transmission system 100 includes a camera 101 capable of capturing a video, a transmission device 102 connectable to an external camera 101, and a camera control unit (CCU) 103 provided in, for example, a control room of a broadcasting station.

The camera 101 is, for example, a television camera that captures a video used for television broadcasting and transmits the camera video that is being captured to an external device in the form of a baseband signal. In this example, the camera 101 transmits a camera video whose baseband signal is a high definition serial digital interface (HD-SDI) to the transmission device 102 connected by a coaxial cable. The baseband signal is not limited to the HD-SDI signal and may be, for example, a high-definition multimedia interface (HDMI) (registered trademark) signal.

The transmission device 102 receives a video signal from the external camera 101 in the form of a baseband signal and converts the video signal into an IP signal to transmit the video. In this example, the transmission device 102 compresses the camera video of the HD-SDI received from the camera 101 using a predetermined image or audio codec (for example, H.264 or MPEG-4 AVC). The transmission device 102 converts the compressed data into an IP signal of a predetermined transfer protocol, such as MPEG2-transport stream (TS), and transmits it to an IP switch 104 connected via a LAN cable. The IP switch 104 transmits the IP signal received from the transmission device 102 to the CCU 103 via the Internet optical communication line. A plurality of the cameras 101 may be connected to the IP switch 104.

The CCU 103 is an electronic device for remotely adjusting the aperture, color tone, and the like of the camera 101. In this example, the CCU 103 receives an IP signal transmitted from the transmission device 102 via the IP switch 105 connected by LAN cable, decodes the IP signal, and outputs a camera video of HD-SDI. In the control room of the broadcasting station, the distribution video of television broadcasting is edited based on the camera video output from the CCU 103 and is aired on the ground wave. A plurality of the CCUs 103 may be connected to the IP switch 105.

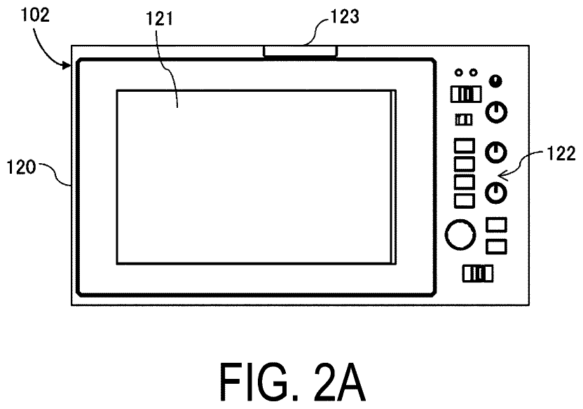

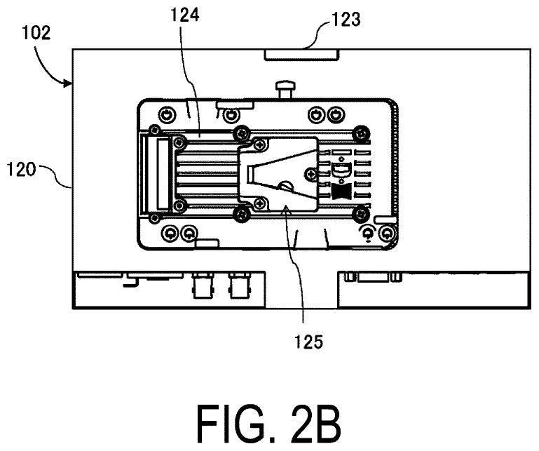

A physical configuration of the transmission device 102 will be described. FIG. 2A is a front view of the transmission device 102. FIG. 2B is a rear view of the transmission device 102. The transmission device 102 includes a display 121 provided in a housing 120 thereof. The display 121 is provided on a first surface widest of a plurality of side surfaces included in the housing 120. An attachment unit 125 for attaching the housing 120 to the camera 101 is provided on a second surface different from the first surface of the plurality of side surfaces.

In this example, as illustrated in FIG. 2A and FIG. 2B, the transmission device 102 has a box-shaped housing 120 that is thin in the front-rear direction. The longitudinal direction of the housing 120 is the left-right direction, and the lateral direction of the housing 120 is the up-down direction. The housing 120 is provided with a display 121, an operation unit 122, a tally lamp 123, a battery mount 124, an attachment unit 125, and the like. The display 121 is a horizontally long liquid crystal display provided on the widest front surface in the housing 120 and including a capacitive touch panel. The display 121 does not need to include an operation unit such as a touch panel or may be a display other than a liquid crystal display (for example, an organic electroluminescent display).

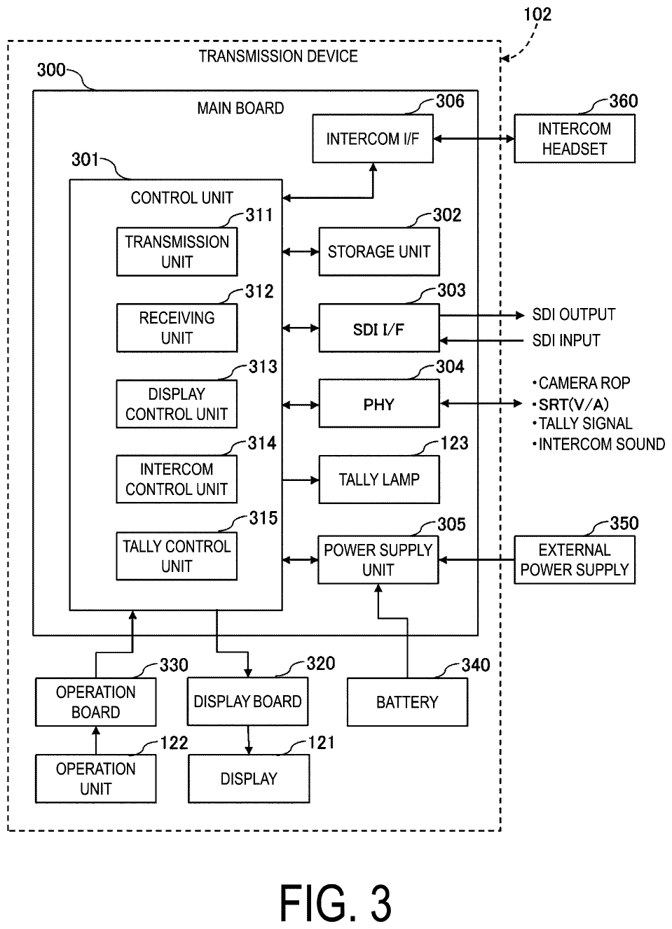

The operation unit 122 is provided on the right side of the display 121 on the front surface of the housing 120. The operation unit 122 includes various switches and dials for operating the transmission device 102, and various LEDs for notifying a state relating to the transmission device 102. The tally lamp 123 is an LED provided on both the upper portion of the front surface and the upper portion of the rear surface of the housing 120 so as to be visible from any of the front and rear sides of the transmission device 102. The battery mount 124 is a portion provided on the rear surface side of the housing 120 and to and from which the battery 340 (see FIG. 3) is attached and detached.

The attachment unit 125 is a portion for attaching the transmission device 102 to the camera 101. The attachment unit 125 has a plurality of screw holes to which an indexing screw for attaching the transmission device 102 to the camera 101 is fixed on the rear surface side of the housing 120. By providing the attachment unit 125 on the rear surface side of the housing 120, the cameraman can view the display 121 on the front surface side of the housing 120 in a state where the transmission device 102 is attached to the camera 101. The attachment unit 125 may be attached to a member in the vicinity of the camera 101 (for example, a support base of the camera 101) instead of being attached to the camera 101 itself.

Although not shown, various interfaces such as a DC power input terminal which is an input terminal of the external power supply 350 (see FIG. 3), an intercom audio input/output terminal, an HD-SDI video input/output terminal, a LAN input/output terminal, and other connection terminals such as D-sub and USB are provided on the bottom surface of the housing 120. In this example, a coaxial cable for connecting to the camera 101 is connected to the video input terminals of HD-SDI in the housing 120. A LAN cable for connection with the IP switch 104 is connected to the LAN input/output terminal in the housing 120.

An electrical configuration of the transmission device 102 will be described. FIG. 3 is a block diagram illustrating an electrical configuration of the transmission device 102. As illustrated in FIG. 3, a main board 300, a display board 320, an operation board 330, a battery 340 mounted on a battery mount 124, and the like are accommodated in a housing 120 of the transmission device 102.

The main board 300 includes a control unit 301, a storage unit 302, an SDI interface 303, a physical layer (PHY) 304, a power supply unit 305, an intercom interface 306, and a tally lamp 123. The control unit 301 is a processor such as a CPU, and in this example, an IP interface and a video or audio codec are implemented. The storage unit 302 includes an information recording medium such as a hard disk, a ROM, or a RAM, and holds a program to be executed by the control unit 301.

The SDI interface 303 is a circuit or a chip for controlling input/output of SDI video to and from an external device. In this example, the SDI interface 303 inputs the camera video received from the camera 101 connected to the video input terminal of the HD-SDI to the control unit 301. The SDI interface 303 can transmit an HD-SDI video to an external device connected to an HD-SDI video output terminal. For example, the SDI interface 303 transmits, as a return video, the camera video being captured, which is received from the camera 101, to the camera 101 connected to the video output terminal or an external display, thereby causing the viewfinder of the camera 101 or the external display to display the camera video that is being captured.

The PHY 304 is a circuit or a chip for mounting the physical layer of the lowermost layer in the OSI layer model. In this example, the PHY 304 can transmit and receive an IP signal such as a remote operation panel (ROP) signal, a tally signal, an intercom audio, and a streaming video via the IP switch 104 connected to a LAN input/output terminal. The ROP signal is a control signal for remotely operating or adjusting the camera 101 from the CCU 103. The tally signal is a control signal for instructing to turn on or blink the tally lamp from the CCU 103. The intercom audio is, for example, an audio signal of an extension call performed between a cameraman, an operator of a control room, a director of a broadcasting station, and the like.

The PHY 304 transmits and receives an IP signal of a video stream (for example, a camera video that is being captured or a return video to be described later) using a predetermined video transmission protocol. The PHY 304 in this example transmits and receives an IP signal of the MPEG2-TS by using a secure reliable transport (SRT) protocol. The SRT protocol is a video transmission protocol that enables IP transmission of video with high stability and safety.

The power supply unit 305 is connected to the battery 340 and the external power supply 350, and controls power supply to the transmission device 102. The intercom interface 306 controls the input/output of an intercom audio in the intercom headset 360 connected to the audio input/output terminal. The intercom headset 360 is worn by a cameraman who uses the camera 101.

The display board 320 is a controller that displays various images on the display 121 in accordance with instructions from the control unit 301. The operation board 330 is a controller that inputs a signal corresponding to an input operation on the operation unit 122 to the control unit 301.

The control unit 301 of the transmission device 102 includes a transmission unit 311, a receiving unit 312, a display control unit 313, an intercom control unit 314, and a tally control unit 315. These functional blocks are implemented by the control unit 301 executing a program stored in the storage unit 302.

The transmission unit 311 transmits, to a predetermined external device, the camera video that is being captured and is received from the camera 101. In this example, as described above, the transmission unit 311 compresses the camera video of HD-SDI by H.264 or MPEG-4 AVC, converts the compressed video into an IP signal of MPEG2-TS in which the compressed audio is multiplexed on the video, and transmits the IP signal from the PHY 304 to the CCU 103.

The receiving unit 312 receives various return signals from the external device. The receiving unit 312 of the present example receives, from an external device, a return video that is on air on television broadcasting in a form of an IP signal. To be more specific, the CCU 103 transmits, to the transmission device 102 as a return signal, an IP signal of a return video that is a distribution video that is on air on television broadcasting. The PHY 304 of the transmission device 102 receives the return signal transmitted from the CCU 103. The receiving unit 312 decodes the return signal received by the PHY 304 and acquires a return video that is on air.

The display control unit 313 controls the display board 320 to display various screens on the display 121. In this example, the display control unit 313 displays a screen including the return video on the display 121, which will be described in detail below. The intercom control unit 314 controls the intercom interface 306 to input/output an intercom audio in the intercom headset 360. The tally control unit 315 controls turning on or blinking the tally lamp 123. In the present embodiment, the transmission device 102 does not need to include the intercom control unit 314 and the tally control unit 315.

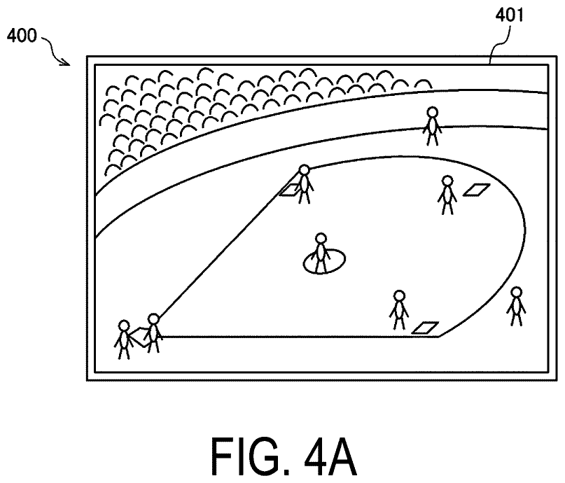

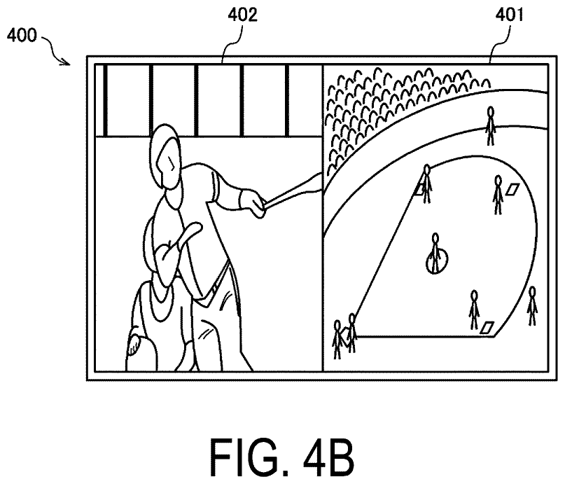

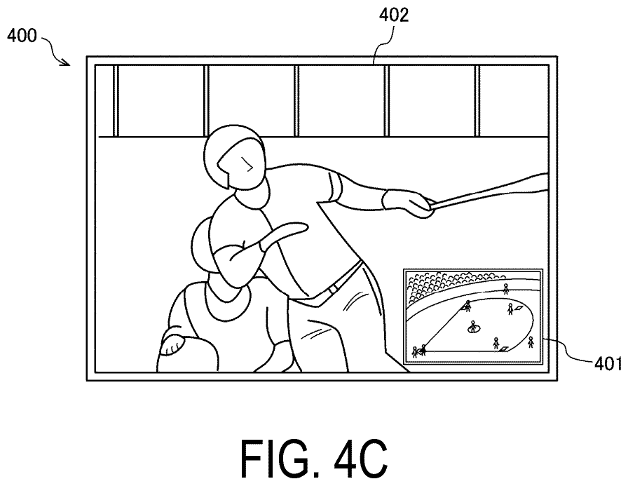

The screen display control of the first embodiment will be described. FIG. 4A is an example of a screen displayed on the transmission device 102 according to the first embodiment. As described above, in the transmission device 102, the transmission unit 311 transmits the IP signal of the camera video that is being captured to the CCU 103. The receiving unit 312 receives, as a return signal from the CCU 103, an IP signal of a return video that is on air. As illustrated in FIG. 4A, the display control unit 313 decodes the return signal into the return video 401 being on air, and displays the screen 400 including the return video 401 on the display 121.

For example, the transmission device 102 may output the camera video that is being captured and the return video that is on air from the SDI interface 303 to the camera 101, as in the conventional transmission device. In this case, the cameraman can appropriately switch and confirm the camera video and the return video on the viewfinder of the camera 101. However, when the switching operation between the camera video and the return video is performed, the display screen of the viewfinder is instantaneously switched, and thus, there is a concern that eye fatigue of the cameraman may increase. If the subject moves while the return video is displayed on the viewfinder, there is a possibility of failing to capture an important moment.

On the other hand, according to the present exemplary embodiment, for example, the return video 401 can be displayed on the display 121 of the transmission device 102 while the camera video that is being captured is displayed on the viewfinder of the camera 101 (see FIG. 4A). The cameraman can simultaneously check the camera video that is being captured and the return video 401 being on air without performing the above-described video switching operation. Thus, the burden on the cameraman is greatly reduced, allowing for suppressing failure of capturing an important moment.

As described below, the display control unit 313 may display the screen 400 including the camera video 402 and the return video 401 on the display 121. FIGS. 4B and 4C are other screen examples displayed on the transmission device 102 according to the first embodiment. The screen 400 illustrated in FIG. 4B displays the camera video 402 and the return video 401 side-by-side. The display control unit 313 may interchange the display positions of the camera video 402 and the return video 401 on the screen 400 or may change the display sizes of the camera video 402 and the return video 401 in response to a key operation on the operation unit 122 or a touch operation on the display 121.

The screen 400 illustrated in FIG. 4C displays the return video 401 superimposed on the camera video 402 in a picture-in-picture manner. In response to a key operation on the operation unit 122 or a touch operation on the display 121, the display control unit 313 may display the camera video 402 superimposed on the return video 401 in a picture-in-picture manner or may change the display size of a video to be displayed on the front side among the camera video 402 and the return video 401.

Although not illustrated, the display control unit 313 may display, on the display 121, the screen 400 of an overlay video obtained by combining the camera video 402 and the return video 401 so as to overlap each other.

In this manner, the screen 400 including the camera video 402 and the return video 401 is displayed on the display 121 by a display method such as side-by-side, picture-in-picture, or overlay. For example, even when the camera 101 is not provided with a viewfinder, the cameraman can simultaneously check the camera video 402 being captured and the return video 401 being on air only by viewing the screen 400 on the display 121 of the transmission device 102.

### Second Embodiment

A second embodiment of the present disclosure will be described. The following embodiments are different from the first embodiment in screen display control. In the following embodiments, the same or corresponding components or processes as those in the first embodiment are denoted by the same reference numerals, the description thereof will be omitted, and differences from the first embodiment will be described.

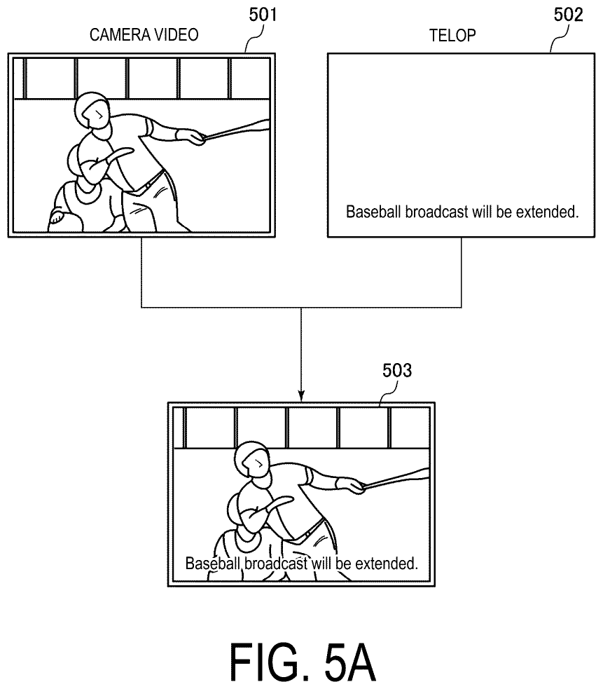

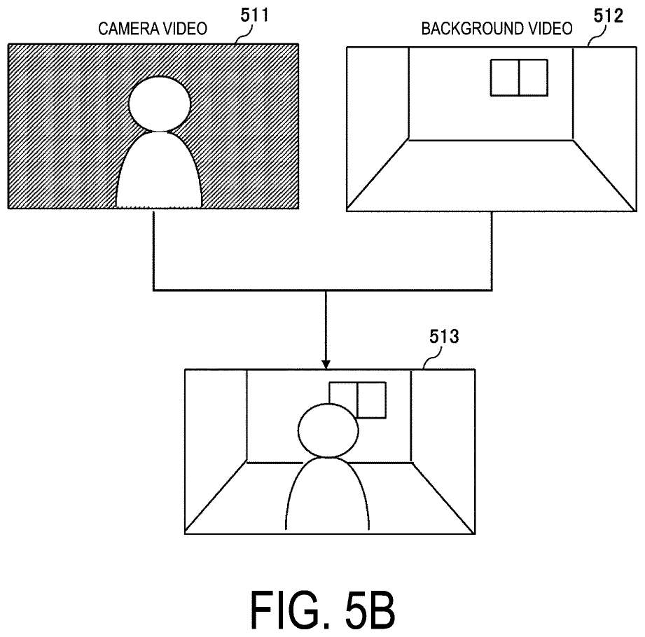

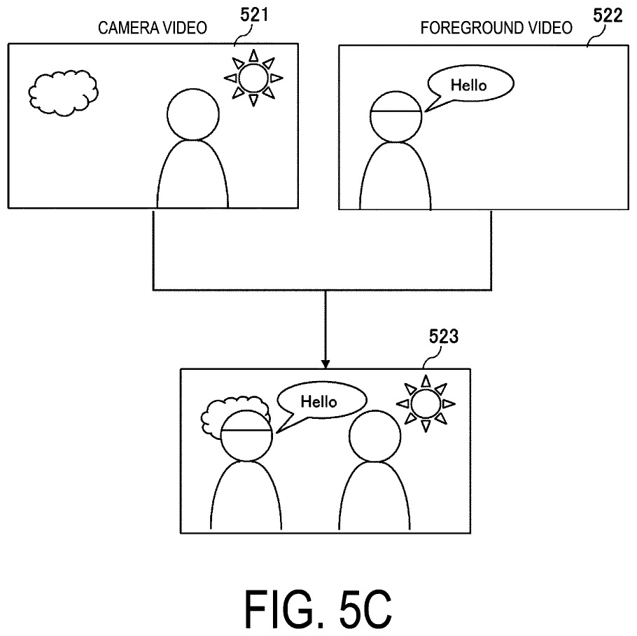

FIG. 5A is a first example of a screen displayed on the transmission device 102 according to the second embodiment. In a first example of the second embodiment, the receiving unit 312 receives, from an external device, information indicating a telop to be displayed on television broadcasting. To be more specific, in the transmission device 102, the transmission unit 311 transmits the IP signal of a camera video 501 being captured to the CCU 103. The receiving unit 312 receives an IP signal of telop information as a return signal from the CCU 103.

The telop information may be a stream video of a telop 502 used in the distribution video of television broadcasting, a still image of the telop 502, or video information indicating the character, color, size, position, and the like of the telop 502 in the distribution video. As illustrated in FIG. 5A, the display control unit 313 decodes the return signal into telop information, and based on this telop information, displays on the display 121 a screen 503 of the telop 502 to be displayed superimposed on the camera video 501.

According to the first example described above, the cameraman can simultaneously confirm the camera video 501 being captured and the telop 502 displayed on television broadcasting only by viewing the screen 503 illustrated in FIG. 5A. This allows the cameraman to adjust the capturing range, zoom, and the like of the camera 101 so that, for example, an important subject does not overlap the telop 502. As in the first embodiment, the camera video 501 and the telop 502 may be displayed on the screen 503 in a side-by-side or picture-in-picture manner.

FIG. 5B is a second example of a screen displayed on the transmission device 102 according to the second embodiment. FIG. 5C is a third example of a screen displayed on the transmission device 102 according to the second embodiment. In the second and third examples of the second embodiment, the receiving unit 312 receives, from an external device, at least one of a background video or a foreground video displayed on television broadcasting. The display control unit 313 displays, on the display 121, a screen obtained by combining the camera video and at least one of the background video or the foreground video.

As illustrated in FIG. 5B, in the second example of the second embodiment, the cameraman uses the camera 101 to capture a chroma-key image of a subject with a specific background color (for example, blue or green). The transmission unit 311 transmits the IP signal of the camera video 511 during chroma-key capturing to the CCU 103. The receiving unit 312 receives the IP signal of the background video 512 for chroma-key synthesis as a return signal from the CCU 103. The display control unit 313 decodes the return signal into the background video 512, and displays a screen 513 obtained by chroma-key combining the camera video 511 and the background video 512 on the display 121.

According to the second example described above, the cameraman can simultaneously confirm the camera video 511 during chroma-key capturing and the background video 512 displayed on television broadcasting only by viewing the screen 513 illustrated in FIG. 5B. This allows the cameraman to adjust the capturing range, zoom, and the like of the camera 101 so that, for example, the subject appears at an appropriate position in relation to the background video 512. As in the first embodiment, the camera video 511 and the background video 512 may be displayed on the screen 513 in a side-by-side or picture-in-picture manner.

As illustrated in FIG. 5C, in the third example of the second embodiment, the transmission unit 311 transmits the IP signal of the camera video 521 being captured to the CCU 103. The receiving unit 312 receives a foreground video 522 for augmented reality (AR) synthesis as a return signal from the CCU 103. The display control unit 313 decodes the return signal into the foreground video 522, and displays a screen 523 obtained by combining the camera video 521 and the foreground video 522 on the display 121.

According to the third example described above, the cameraman can simultaneously confirm the camera video 521 for AR combination and the foreground video 522 displayed on television broadcasting only by viewing the screen 523 illustrated in FIG. 5C. This allows the cameraman to adjust the capturing range, zoom, and the like of the camera 101 so that, for example, the subject appears at an appropriate position in relation to the foreground video 522. As in the first embodiment, the camera video 521 and the foreground video 522 may be displayed on the screen 523 in a side-by-side or picture-in-picture manner.

### Third Embodiment

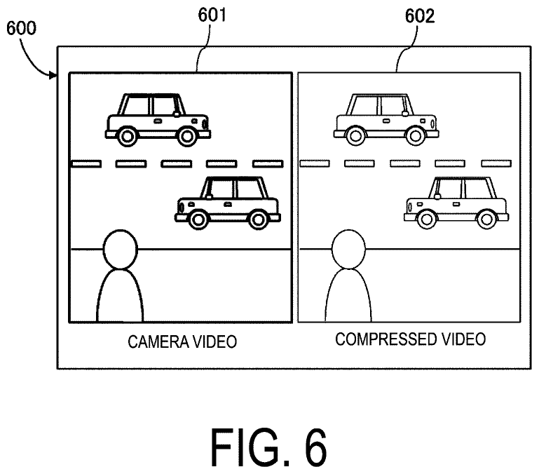

A third embodiment of the present disclosure will be described. FIG. 6 is an example of a screen displayed on the transmission device 102 according to the third embodiment. In the third embodiment, the transmission unit 311 compresses the camera video that is being captured by a compression method identical to a compression method of the distribution video on television broadcasting and transmits the compressed camera video to the external device. In this example, the video of television broadcasting distributed from the broadcast station is compressed by H.264/MPEG-4 AVC. Thus, the transmission unit 311 compresses the camera video of HD-SDI by H.264/MPEG-4 AVC and transmits the compressed camera video to the CCU 103.

As illustrated in FIG. 6, the display control unit 313 displays, on the display 121, a screen 600 including a camera video 601 before compression and the camera video after compression (compressed video 602) in the transmission unit 311. For example, the display control unit 313 displays the camera video 601 of HD-SDI being captured and the compressed video 602 obtained by compressing the camera video 601 by H.264/MPEG-4 AVC on the screen 600 in a side-by-side manner.

According to this, the cameraman can simultaneously confirm the camera video 601 being captured and the compressed video 602 obtained by compressing the camera video 601 only by viewing the screen 600 illustrated in FIG. 6. The cameraman can visually grasp how much the camera video 601 is compressed and how the image quality and the hue change when the camera video 601 is used on television broadcasting. For example, the cameraman can compare the camera video 601 with the compressed video 602 and appropriately adjust a function such as edge enhancement of the camera 101 so as to obtain a desired distribution video.

The present embodiment can generate and display the compressed video 602 by using the video compression function of the transmission device 102, thus allowing the above-described function can be easily implemented without separately adding a compression circuit for generating the compressed video 602. The video compression method is not limited to H.264/MPEG-4 AVC, and the compressed video 602 is generated by the same method as the compression method of television distribution video, such as MPEG-2 or H.265 (HEVC).

### Fourth Embodiment

A fourth embodiment of the present disclosure will be described. In the fourth embodiment, the transmission unit 311 transmits the camera video and the non-intercom audio to the external device by using the first protocol for multiplexing the compressed audio on the video. In this example, from a microphone provided in the camera 101 or an external microphone connected to the transmission device 102, for example, a non-intercom audio which is an audio of a studio or a concert hall which is a capturing target is input to the transmission device 102. The transmission unit 311 multiplexes the non-intercom audio with the camera video using the MPEG2-TS, converts the multiplexed signal into an IP signal, and transmits the converted signal to the CCU 103.

The intercom control unit 314 (see FIG. 3) transmits and receives, by using the second protocol that transmits only the audio without compression, the intercom audio to and from the external device with a delay smaller than that of the first protocol. In this example, the intercom control unit 314 converts the intercom audio of the cameraman input from the intercom headset 360 into an uncompressed IP signal using a real-time transport protocol (RTP) and transmits the IP signal to the CCU 103. When the PHY 304 receives an intercom audio of an operator or the like from the CCU 103 by RTP, the intercom control unit 314 decodes an IP signal of the intercom audio and outputs the IP signal from the intercom headset 360.

As described above, in the present embodiment, the non-intercom audio and the intercom audio use different protocols from each other, and the non-intercom audio is multiplexed with the camera video and transmitted, whereas the intercom audio is transmitted without being compressed. As a result, since a delay is less likely to occur in an intercom audio than in a non-intercom audio, for example, a cameraman or an operator can perform a smooth intercom call in which an audio delay is suppressed.

### Fifth Embodiment

A fifth embodiment of the present disclosure will be described. In the fifth embodiment, the tally control unit 315 (sec FIG. 3) has at least one of a function of turning on or blinking the tally lamp 123 provided in the housing 120 of the transmission device 102 or a function of displaying an image based on the tally signal on the display 121 when receiving the tally signal from the external device.

In this example, when the PHY 304 receives an IP signal of the tally signal from the CCU 103, the tally control unit 315 turns on or blinks the tally lamp 123. Instead of this, or in addition to this, the tally control unit 315 causes the display 121 to display, for example, a message “video of this camera is on the air” or an icon indicating that it is on the air as an image based on the tally signal.

As described above, in the present embodiment, the transmission device 102 has a tally display function and can receive a tally signal via an IP line in the same manner as other video and signals. Therefore, even in a case where the camera 101 is not provided with a tally display device, capturing operation using a tally in the transmission device 102 can be performed without separately preparing a tally display device.

### Remarks

The present disclosure is not limited to the above-described embodiments, and various modifications are possible within the scope of the claims. Embodiments obtained by appropriately combining technical means disclosed in different embodiments are also included in the technical scope of the present disclosure. Further, by combining the techniques disclosed in the different embodiments, novel technical advantages can be formed.

In the above-described embodiment, a case where the functional blocks such as the transmission unit 311, the receiving unit 312, the display control unit 313, the intercom control unit 314, and the tally control unit 315 are provided in the control unit 301 of the transmission device 102 has been exemplified. Alternatively, some or all of these functional blocks may be provided in another electronic device connected to the transmission device 102. In this case, some or all of the processes described in the above embodiments are executed by another electronic device connected to the transmission device 102, and the processing load of the transmission device 102 can be reduced.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A transmission device configured to receive a video signal from an external camera in a form of a baseband signal and convert the video signal into an IP signal to transmit a video, the transmission device comprising:
a transmission unit configured to transmit, to a predetermined external device, a camera video that is being captured and is received from the camera; and
a display provided in a housing of the transmission device.

2. The transmission device according to claim 1, further comprising:
a receiving unit configured to receive, from the external device, a return video that is on air on television broadcasting in a form of an IP signal; and
a display control unit configured to display a screen including the return video on the display.

3. The transmission device according to claim 2, wherein
the display control unit displays a screen including the camera video and the return video on the display.

4. The transmission device according to claim 1, further comprising:
a receiving unit configured to receive information indicating a telop to be displayed on television broadcasting from the external device; and
a display control unit configured to display, on the display, a screen of the telop to be displayed superimposed on the camera video.

5. The transmission device according to claim 1, further comprising:
a receiving unit configured to receive, from the external device, at least one of a background video or a foreground video displayed on television broadcasting; and
a display control unit configured to display, on the display, a screen of the camera video combined with at least one of the background video or the foreground video.

6. The transmission device according to claim 1, wherein
the transmission unit compresses the camera video that is being captured by a compression method identical to a compression method of a distribution video of television broadcasting and transmits a compressed camera video to the external device, and
the transmission device further comprises a display control unit configured to display, on the display, a screen including the camera video before compression and the camera video after compression in the transmission unit.

7. The transmission device according to claim 1, wherein
the transmission unit transmits the camera video and a non-intercom audio to the external device using a first protocol for multiplexing a compressed audio onto a video, and
the transmission device further comprises an intercom control unit configured to transmit and receive, by using a second protocol for transmitting only an audio in a non-compressed manner, an intercom audio to and from the external device with a delay smaller than a delay of the first protocol.

8. The transmission device according to claim 1, further comprising a tally control unit having at least one of a function of turning on or blinking a tally lamp provided in a housing of the transmission device or a function of displaying an image based on a tally signal on the display when receiving the tally signal from the external device.

9. The transmission device according to claim 1, wherein
the display is provided on a first surface widest of a plurality of side surfaces included in the housing, and
an attachment unit for attaching the housing to the camera is provided on a second surface different from the first surface of the plurality of side surfaces.
